(19) United States
(12) Patent Application Publication
(10) Pub. No.: US 2010/0073251 A1
(43) Pub. Date: Mar. 25, 2010

(54) BEHIND-THE-WALL ANTENNA SYSTEM

(75) Inventors: Shizuo MIZUSHINA, Hamamatsu-shi (JP); Atsushi ADACHI, Hamamatsu-shi (JP)

Correspondence Address: VENABLE LLP, P.O. BOX 34385, WASHINGTON, DC, 20043-9998, US

(73) Assignee: Enegene Co., Ltd., Hamamatsu-shi (JP)

(21) Appl. No.: 12/413,216

(22) Filed: Mar. 27, 2009

(30) Foreign Application Priority Data
Sep. 24, 2008 (JP) 2008-243948

(51) Int. Cl. H01Q 19/10; H01Q 21/28

(52) U.S. Cl. 343/818; 343/834; 343/836

(57) ABSTRACT

A behind-the-wall antenna system according to the present invention comprises: a wall; a converging reflector (corner reflector) which reflects radio waves so as to form a region behind the wall in which the electric field strength is great; an antenna arranged in the region between the wall and the converging reflector in which the electric field strength is greater than that in the surroundings; and a transmission path connected to the antenna. A resonance space is formed between the front face of the wall and the converging reflector. Furthermore, the distance between the wall and the reflector is adjusted so as to create an impedance matching state between the antenna and the space on the front side of the wall. With such an arrangement, the radio waves are directly used behind the wall.

### BACKGROUND OF THE INVENTION

1. Field of the Invention

The present invention relates to a behind-the-wall antenna system which uses radio waves which have reached the space on one face side of a wall or floor of a building or the like (which will be referred to as “the space behind the wall” or “the behind-the-wall space” hereafter in the present specification) after the incident radio waves have been received via the other face thereof and the radio waves thus received have decayed.

2. Description of the Related Art

In an information communication network, the application range of wireless communication techniques which employ radio waves propagating via the atmosphere is expanding. It is known that walls (e.g., walls or floors of a concrete building) lead to transmission loss to the radio waves used in the information communication. In order to avoid such an adverse effect, a great number of proposals have been made, examples of which include: a method in which the radio waves are received via a dedicated antenna before they decay in a wall, and the radio waves thus received are introduced to the other space via a transmission path; a method in which the radio waves thus received are further amplified, and the amplified radio waves are emitted into the room; etc. An antenna system is described in Japanese Unexamined Patent Application Publication No. H08-331028, which discloses a method (the method generally employed) in which, in order to use external radio wave information in a space partitioned by a wall or the like non-transmissive to radio waves, the radio waves are received at the outside (one side) space, the radio waves thus received are introduced into the inner (the other side) space via a transmission path, the radio waves thus introduced are amplified and emitted to the inner space via an antenna again, and the user in the inner space receives and uses the radio waves via his/her own receiving device. Also, the invention described in Japanese Unexamined Patent Application Publication No. 2007-270459 relates to a building-wall material and a wireless transmission system in which the wall material includes a radio-wave transmission portion. With such an arrangement, a hole is formed in the wall, and a lens antenna is provided to the hole, thereby allowing the antennas on both sides to communicate with each other across the wall. Also, the invention described in Japanese Unexamined Patent Application Publication No. 2007-043280 relates to an underground wireless communication system, which proposes an arrangement in which the radio waves emitted via an underground antenna installed within a manhole are emitted externally via a ring-shaped concrete radio-wave emission face provided to the perimeter of the manhole cover formed of iron, and the radio waves thus emitted are received via an antenna installed on the ground.

### SUMMARY OF THE INVENTION

The present invention has been made in order to develop a technique for reducing the adverse effects of the radio wave transmission loss due to a concrete wall or the like without modifying the wall as described above. The present inventor et al., focused on the fact that, by acquiring the radio waves at a reduced magnitude over as wide an area as possible after transmission via the wall, and by concentrating the radio waves thus acquired on a narrow area, the region having high electric field strength can be formed.

It is an object of the present invention to provide a behind-the-wall antenna system which uses radio waves behind the wall, in which the behind-the-wall antenna system is configured including a wall in which the radio waves decay, the radio waves at a reduced magnitude are acquired over as wide an area as possible after transmission via the wall, and the radio waves thus acquired are concentrated on a narrow area, thereby forming a region having high electric field strength.

In order to achieve the aforementioned object, a behind-the-wall antenna system according to an aspect of the present invention comprises: a wall; a converging reflector which reflects radio waves so as to form a region behind the wall in which the electric field strength is great; an antenna arranged in the region between the wall and the converging reflector in which the electric field strength is greater than that in the surroundings; and a transmission path connected to the antenna. With such an arrangement, a resonance space is formed between the front face of the wall and the converging reflector. Furthermore, the distance between the wall and the reflector is adjusted so as to create an impedance matching state between the antenna and the space on the front side of the wall. Moreover, the radio waves are directly used behind the wall.

A λ/4-dielectric plate may be disposed behind the wall. Also, the converging reflector (first converging reflector) and the antenna (first antenna) may form a first antenna assembly. Furthermore, a second converging reflector, which is arranged in a back-to-back manner with respect to the first converging reflector, and a second antenna for radiating radio waves, which is arranged such that it is corresponds to the second converging reflector and which is connected to the transmission path, may form a second antenna assembly. Moreover, an additional electric field distribution may be formed in a space behind the wall by means of the second antenna assembly.

An amplifier may be connected to the transmission path. Also, the first and second converging reflectors may be corner reflectors. Furthermore, each of the first and second antennas may be at least one dipole antenna.

Each of the first and second antenna assemblies may further include an upper conductor plate and a lower conductor plate. Also, the second antenna may further form an additional region (hot spot) in which the electric field strength is greater than that in the surroundings, further behind the second converging reflector.

The second antenna assembly may include a rear-side upper conductor plate and a rear-side lower conductor plate, which provides the reflected waves from the output side of the rear-side upper conductor plate and the rear-side lower conductor plate. Also, each of the rear-side upper conductor plate and the rear-side lower conductor plate of the second antenna assembly may have a semicircular shape. Furthermore, the hot spot may be applied to an indoor LAN repeater apparatus.

The radio waves acquired by the first antenna may be converged in the vertical direction and the horizontal direction by means of the second antenna assembly so as to output a radiation beam with a high electric field strength. Also, the first and second antenna assemblies are arranged such that the corner reflectors are arranged in a back-to-back manner. Furthermore, the antenna of each antenna assembly may be a dipole antenna array.

The apex angle of the corner reflector of the second antenna assembly may be smaller than the apex angle of the corner reflector of the first antenna assembly. Also, the electromagnetic field may be concentrated in the antenna array direction using the difference in the magnitude of the reactance component due to the capacitive coupling between the adjacent antenna elements of the dipole antenna array.

The behind-the-wall antenna system according to the present invention provides an open-type resonance apparatus, thereby effectively capturing radio waves in front of the wall. Also, the behind-the-wall antenna system prevents standing waves from occurring in the wall, thereby improving the radio-wave transmissivity with respect to the wall. Furthermore, such a behind-the-wall antenna system markedly facilitates adjustment.

In such a behind-the-wall antenna system, a second antenna assembly may be formed of a second converging reflector arranged in a back-to-back manner with respect to the first converging reflector and a second antenna for radio wave radiation which is arranged such that it corresponds to the second converging reflector and which is connected to the transmission path. Such an arrangement is capable of forming an additional electric field distribution in a space behind the wall by means of the second antenna assembly.

With such a behind-the-wall antenna system according to the present invention, by connecting an amplifier to the transmission path, the received signal received by the first antenna can be directly used. Also, a hot spot can be generated by means of the second antenna assembly. Furthermore, the second antenna assembly is capable of converging the radio waves in the vertical direction and the horizontal direction so as to output a radiation beam with a high electric field strength.

### BRIEF DESCRIPTION OF THE DRAWINGS

FIG. 1 is a perspective view which shows a three-dimensional electromagnetic field distribution in an environment model space 1 to which a behind-the-wall antenna system according to the present invention is applied;

FIG. 2 is a graph which shows the change in the electric field strength of radio waves along an electric field strength observation axis in the environment model space 1 (FIG. 1);

FIG. 3 is a perspective view which shows a three-dimensional electromagnetic field distribution in an environment model space 2 (λ/4-dielectric plate is arranged) to which a behind-the-wall antenna system according to the present invention is applied;

FIG. 4 is a graph which shows the change in the electric field strength of radio waves input along an electric field strength observation axis in the environment model space 2 (FIG. 3);

FIG. 5 is a perspective view which shows a state in which a first antenna assembly is arranged in the environment model space 2 (FIG. 3);

FIG. 6 is a perspective view of the first antenna assembly picked up from FIG. 5, which shows the λ/4-dielectric plate 6 as a part of the assembly;

FIG. 7 is an enlarged view for describing the relation among a dipole antenna, a transmission path, and a corner reflector;

FIG. 8 is an explanatory diagram which shows an electric field strength distribution on a vertical plane including the electric field strength observation axis in the environment model space 2 to which the first antenna assembly is applied according to the embodiment;

FIG. 9 is an explanatory diagram which shows an electric field strength distribution on a horizontal plane including the electric field strength observation axis in the environment model space 2 to which the first antenna assembly is applied according to the embodiment;

FIG. 10 is a graph which shows an electric field strength distribution profile in the environment model space 2 to which the first antenna assembly is applied according to the embodiment;

FIG. 11 is a graph which shows an electric field strength distribution profile in a free space in which a reference dipole antenna is arranged in a state in which a plane wave (electric field strength of 1 V/m) is emitted;

FIG. 12 is a graph which shows a one-dimensional electric field strength distribution in a state in which a dipole antenna is arranged behind a concrete wall, and a plane wave (electric field strength of 1 V/m) is emitted;

FIG. 13 is a perspective view which shows a behind-the-wall antenna system including a first antenna assembly and a second antenna assembly in the environment model space 2, which generates an additional region (hot spot) in which the electric field strength is greater than that in the surroundings further behind the second reflector of the second antenna assembly;

FIG. 14 is a vertical cross-sectional view (A) and a horizontal cross-sectional view (B) of the embodiment of the behind-the-wall antenna system which generates the hot spot shown in FIG. 13;

FIG. 15 is a vertical cross-sectional view which shows the first antenna assembly and the second antenna assembly of the behind-the-wall antenna system which generates the hot spot shown in FIG. 13;

FIG. 16 is an explanatory diagram which shows an electric field strength distribution on a vertical plane including the electric field strength observation axis in the embodiment of the behind-the-wall antenna system which generates a hot spot behind the second antenna assembly in the environment model space 2 to which the first antenna assembly and the second antenna are applied;

FIG. 17 is an explanatory diagram which shows an electric field strength distribution on a horizontal plane including the electric field strength observation axis in the embodiment of the behind-the-wall antenna system which generates a hot spot behind the second antenna assembly;

FIG. 18 is a graph which shows an electric field (vertical direction) strength distribution along the electric field strength observation axis in the embodiment of the behind-the-wall antenna system which generates a hot spot behind the second antenna assembly;

FIG. 19 is a graph which shows the electric field strength distribution obtained by expanding the vertical-axis scale in FIG. 18;

FIG. 20 is a schematic perspective view (A), a plan cross-sectional view (B) and a vertical cross-sectional view (C) which show an embodiment of the behind-the-wall antenna system which includes the first antenna assembly and the second antenna assembly in the environment model space 2, and which generates a behind-the-wall beam behind the second antenna assembly;

FIG. 21 is a perspective view which shows the relation between the wall and the system included in the behind-the-wall antenna system which generates a behind-the-wall beam shown in FIG. 20;

FIG. 22 is an explanatory diagram which shows an electric field strength distribution on a vertical plane including an electric field strength observation axis C2 in the behind-the-wall antenna system which generates a behind-the-wall beam behind the second antenna assembly in the environment model space 2 to which the first antenna assembly and the second antenna assembly are applied;

FIG. 23 is an explanatory diagram which shows an electric field strength distribution on a horizontal plane including the electric field strength observation axis C2 in the behind-the-wall antenna system which generates a behind-the-wall beam behind the second antenna assembly;

FIG. 24 is a graph which shows an electric field strength distribution along the electric field observation axis C2 (axis of the central antenna pair) in the behind-the-wall antenna system which generates a behind-the-wall beam behind the second antenna assembly;

FIG. 25 is a graph which shows an electric field strength distribution along the electric field observation axis C2 (axis of the central antenna pair) in the behind-the-wall antenna system which generates a behind-the-wall beam behind the second antenna assembly, which is obtained by expanding the vertical-axis scale in FIG. 24; and

FIG. 26 is a graph which shows an electric field strength distribution along an electric field observation axis C1 (C3) in the behind-the-wall antenna system which generates a behind-the-wall beam behind the second antenna assembly.

### DESCRIPTION OF THE PREFERRED EMBODIMENTS

Description will be made regarding a behind-the-wall antenna system according to the present invention with reference to the drawings etc. First, detailed description will be made regarding an example of an environment to which the system according the present invention is applied.

### [Radio Wave Frequency and Wall Properties]

The radio waves are employed with a frequency band of 2.4 GHz, which are widely employed in conventional wireless LAN. A concrete wall is selected here as the aforementioned wall. The ITU report 1238 suggests the recommended value (7.0-j 0.85) for the complex dielectric constant of the concrete, which indicates the dielectric properties thereof, with respect to radio waves of 1 GHz. Accordingly, this value is used here as the dielectric properties of concrete with respect to radio waves of 2.4 GHz. This value corresponds to εr=7.0, and tan δ=0.1214.

### [Environment Model Space 1]

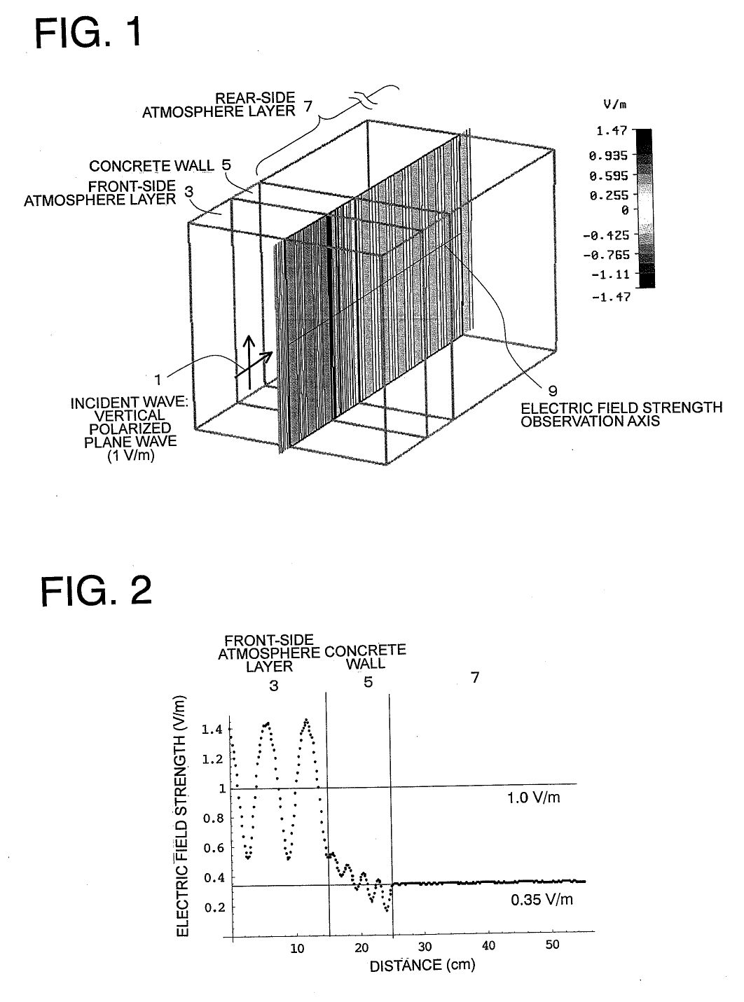

As shown in FIG. 1 and FIG. 2, assuming that the concrete wall is formed with a thickness of 10 cm, the properties of the behind-the-wall antenna system are evaluated by estimating the transmission loss of the radio waves having the frequency of 2.4 GHz due to the concrete wall having a thickness of 10 cm. The electric field of the model space has been visualized by performing three-dimensional electromagnetic field simulation analysis of the radio wave transmission in a state in which an incident plane wave at a frequency of 2.4 GHz is emitted to a concrete wall having a thickness of 10 cm.

FIG. 1 shows an electric field strength distribution in the environment model space 1 when the radio waves having the frequency of 2.4 GHz are transmitted via a concrete wall 5 with a thickness of 10 cm (example without employing a λ/4-dielectric layer). The concrete wall 5 has the dielectric properties of εr=7.0, and tan δ=0.1214. The incident radio wave is a vertical polarized plane wave with an electric field strength of 1 V/m (incident direction 1). A gray scale which indicates the electric field strength is shown on the right side in the drawing.

FIG. 2 shows an electric field strength profile along an electric field strength observation axis 9. The electric field strength profile indicates the electric field strength distribution along the electric field strength observation axis 9 (FIG. 1), and the vertical axis represents the electric field strength in V/m. The electric field strength of the incident wave 1 is reduced from 1 V/m to 0.35 V/m after transmission via the concrete wall 5 with a thickness of 10 cm. At the interface between the atmosphere (front-side atmosphere layer 3) and the concrete wall 5, a reflected wave occurs due to discontinuity of the dielectric constant, and standing waves occurs in the atmosphere in front of the wall and in the interior of the wall. The transmission loss of the radio waves due to the concrete wall 5 is represented by the Expression, 20 log₁₀(0.35/1.0)=−9.12 dB.

### [Environment Model Space 2]

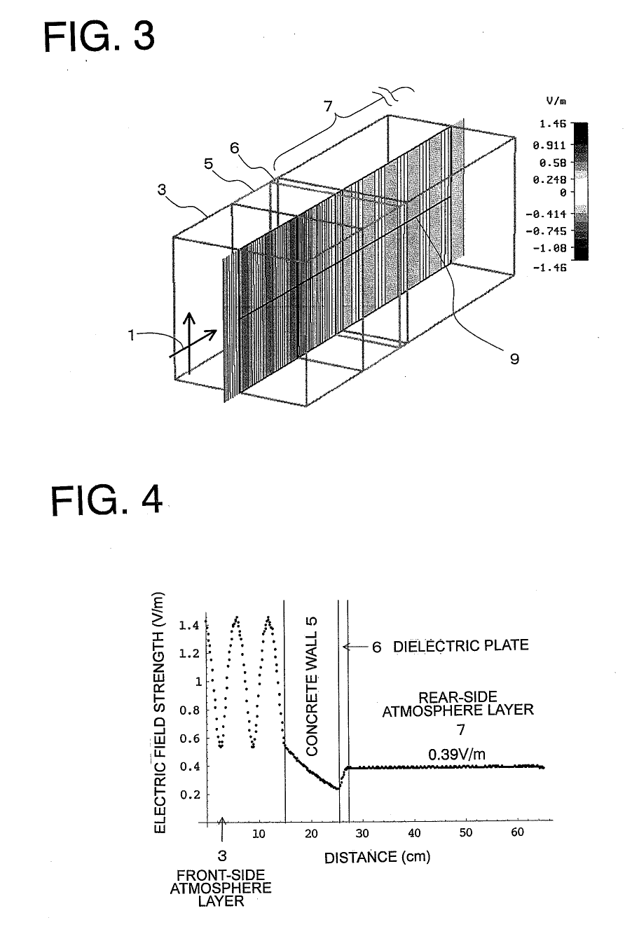

As compared with the model shown in FIG. 1, a λ/4-dielectric plate 6 is provided on the back face of the concrete wall 5. The concrete wall 5 has the same dielectric properties of εr=7.0, and tan δ=0.1214, as those described above. The difference from the environment model space 1 is that the λ/4-dielectric plate 6 (εr=2.65) is provided. FIG. 3 shows an electric field strength distribution in the model space 2 in central vertical cross-section. A gray scale which indicates the electric field strength is shown on the right side in the drawing. FIG. 4 is a graph which indicates the electric field strength along the electric field strength observation axis 9 shown in FIG. 3.

### [Comparison Between the Environment Model Spaces 1 and 2]

Making a comparison between FIG. 2 and FIG. 4, it can be understood that, in FIG. 4, the incident wave is monotonically reduced in the interior of the concrete wall 5 without occurrence of standing wave. The radio waves have an electric field strength of 0.39 V/m in the rear-side atmosphere layer 7. In this case, the transmission loss in the concrete wall 5 is reduced by 0.04 V/m as compared with 0.35 V/m shown in FIG. 2. This means that the λ/4-dielectric plate 6 is preferably employed. That is to say, making a comparison between FIG. 2 and FIG. 4, it can be understood that the introduction of the λ/4-dielectric plate 6 eliminates the standing waves in the interior of the concrete wall. As a result, this reduces the radio wave absorption due to the wall, thereby slightly increasing the electric field strength in the rear-side atmosphere layer. In addition to the aforementioned effect, there is a second effect of the introduction of the λ/4-dielectric plate 6. Description thereof will be made later.

In the space behind the wall in the behind-the-wall antenna system according to the present invention, the usage of the radio waves temporarily concentrated is classified into the following three usages.

### [Basic Usage]

A dipole antenna with a corner reflector is arranged behind the wall, and the radio waves temporarily concentrated by the corner reflector are captured by the dipole antenna.

### [Usage 1]

The usage 1 is a usage in which the output of the dipole antenna is directly used as the input of a receiver.

### [Usage 2]

The usage 2 is a usage in which the electric power received by the dipole antenna is introduced to the space on the back side of the reflector plate via a transmission path, and creates a hot spot in the space on the back side of the antenna. It should be noted that the term “hot spot” represents a region in which the electric field strength thereof is greater than that of the surroundings. In such an arrangement, the hot spot does not indicate a point, but indicates a region surrounded by a closed surface that exhibits the same electric field strength which is greater than a predetermined value, conceived examples of which include a spherical region, a rod-shaped region, etc.

### [Usage 3]

The usage 3 is a usage in which the electric power received by an antenna is introduced to the space on the back side of the reflector plate via a transmission path, and a highly directional antenna is driven so as to generate a radiation beam with an increased electric field strength in the space on the back side of the antenna.

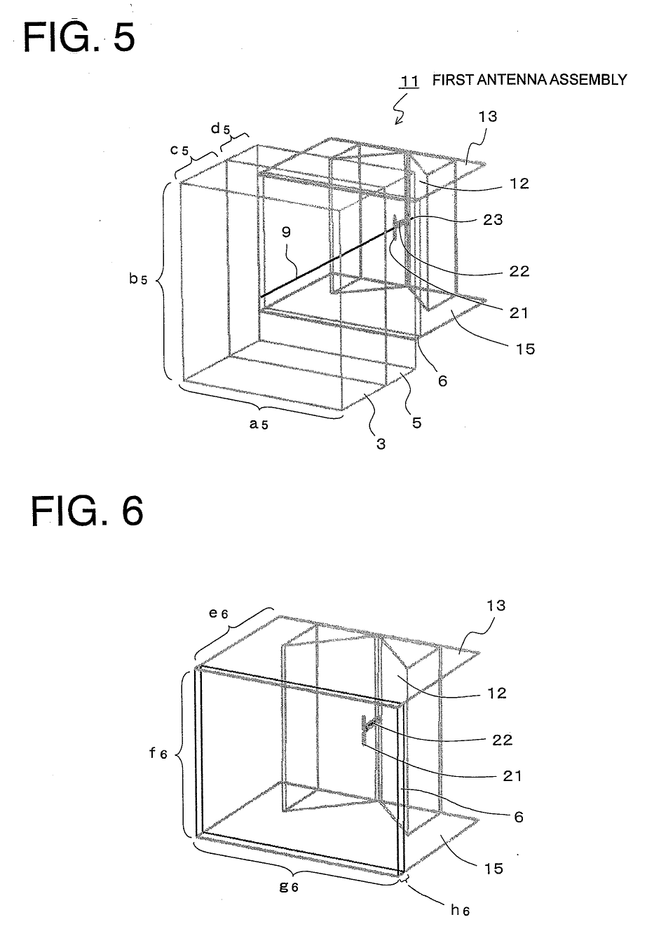

Next, description will be made regarding the embodiment of the aforementioned basic usage with reference to FIG. 5 and FIG. 6. A dipole antenna 21 with a corner reflector 12 is disposed behind a wall 5, and the radio waves are captured by the dipole antenna 21. The forward face of the corner reflector 12 and the wall 5 reflect the incident wave 1, and serve as a converging reflector which creates a region having high electric field strength behind the wall (in front of the reflector face). The antenna 21 is arranged in a region having high electric field strength between the wall 5 and the reflector face of the corner reflector 12. A resonance space is formed for a particular wavelength k between the front face of the wall 5 (interface to the atmosphere layer) and the reflector face of the corner reflector 12. In order to form such a resonance space, the distance between the front face of the wall 5 and the reflector face of the corner reflector 12 is adjusted so as to provide an impedance matching state between the antenna 21 and the space on the front side of the wall. It should be noted that, by arranging the λ/4-dielectric plate 6 behind the wall 5 in this system, such an arrangement prevents the standing wave from occurring in the interior of the wall 5 as described above.

FIG. 5 is a schematic diagram which shows the position relation of an arrangement in which a first antenna assembly 11 is arranged in the environment model space 2 shown in FIG. 3. FIG. 6 is a perspective view of the first antenna assembly 11 picked up from FIG. 5, which shows the λ/4-dielectric plate 6 as a part of the assembly 11. The environment model space 2 shown in FIG. 3 corresponds to the state in which only the dielectric plate 6 is mounted in contact with or adhered to the concrete wall 5.

The first antenna assembly 11 includes the corner reflector 12, an upper conductor plate 13, and a lower conductor plate 15. The dipole antenna 21 is supported by the transmission path (coaxial path) 22 such that the elements thereof are arranged orthogonal to the axis 9, and a signal output terminal 23 is extended backward. The corner reflector 12 has an apex angle of 90°, which reflects the transmitted radio wave in the wall direction via the wall 5 and the dielectric plate 6. With the present embodiment, the first antenna assembly 11 has a configuration including the dielectric plate 6 having a thickness of λ/4, the upper conductor plate 13, the lower conductor plate 15, and the corner reflector 12 in the form of a single unit, thereby providing an antenna unit. In this usage, the λ/4-dielectric plate 6 of the first antenna assembly 11 is mounted in contact with the concrete wall 5.

FIG. 6 shows the first antenna assembly 11 picked up from FIG. 5. By adjusting the mounting state of the upper conductor plate 13, the lower conductor plate 15, and the corner reflector 12, the distance between the antenna 21 of the corner reflector 12 and the λ/4-dielectric plate 6 is maintained at an optimum value. Thus, the antenna impedance matches the impedance of the space on the front side of the wall, thereby forming an open-type resonator described above. By forming a structure shown in FIG. 5 and FIG. 6, the front face of the concrete wall 5 and the corner reflector 12 form the resonator, a part of which is formed to be a region having a high electric field strength. The dipole antenna 21 is arranged in this region having such a high electric field strength, thereby providing the first antenna assembly 11 as a high-sensitive receiving antenna. In FIG. 5, “a5”, “b5”, and “c5” are 32 cm, 36 cm, and 15 cm, respectively, in the calculation space on the front side of the wall. The thickness d5 of the wall is 10 cm. In FIG. 6, “f6”, “g6”, and “h6” of the dielectric plate 6 represent the height, the width, and the thickness, respectively, and are 25 cm, 32 cm, and 1.8 cm, respectively. The front width of the upper conductor plate 13 and the lower conductor plate 15 is the same as g6. The depth e6 thereof is 24.5 cm.

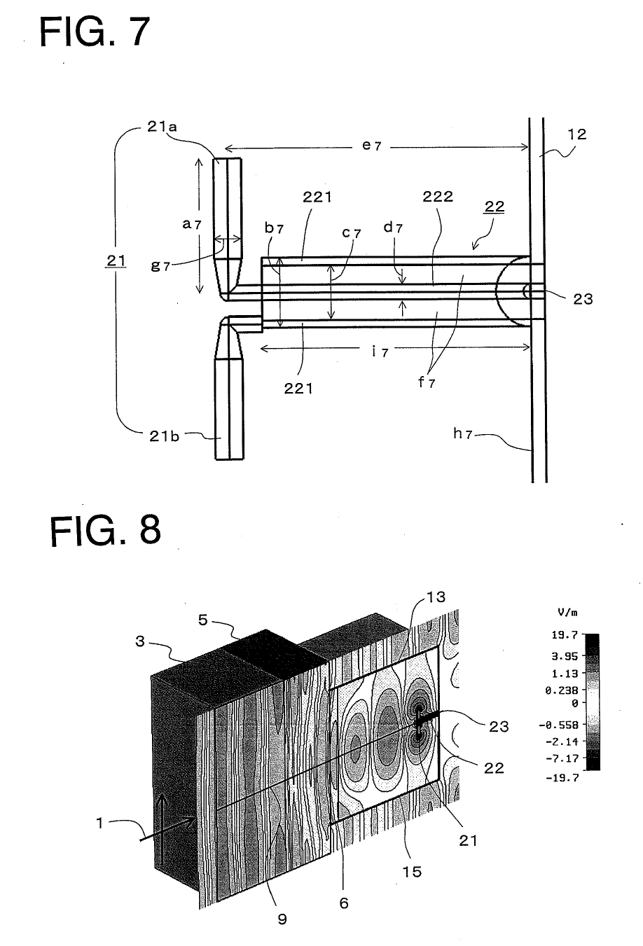

FIG. 7 is an enlarged view for describing the relation among the dipole antenna 21, the transmission path 22, and the corner reflector 12. The radiation impedance of the dipole antenna 21 shown in FIG. 7 and the coaxial path impedance are 50Ω. The incident wave 1 is received by the concrete wall 5 via the front-side atmosphere layer 3, and the incident wave 1 thus received reaches the rear-side atmosphere layer 7 via the λ/4-dielectric plate 6. The components of the incident wave 1 are reflected by the corner reflector 12 so as to form a region in the rear-side atmosphere layer 7 having higher electric field strength than that of the surroundings. The components of the incident wave 1 are received via the dipole antenna 21 in the aforementioned region. An antenna element 21a of the dipole antenna 21 is connected to an inner conductor 222 of the transmission path (coaxial path) 22. Another antenna element 21 is connected to the outer conductor 221 of the transmission path (coaxial path) 22. The transmission path 22 is connected to corner reflector 12 at the apex angle (h7 in FIG. 7). In some cases, the other terminal 23 of the inner conductor 222 is employed as an output terminal.

Next, the value of each portion in the embodiment shown in FIG. 7 will be described. Each of the antenna element 21a and the antenna element 21b are formed with a length a7 of 1.97 cm and with a thickness g7 of 0.4 cm. The distance e7 between the apex angle (h7 in FIG. 7) of the corner reflector 12 and each of the antenna elements 21a and 21b is 4.925 cm. The diameter b7 of the outer conductor 221 of the transmission path (coaxial path) 22 is 1.024 cm. The inner diameter c7 of the outer conductor 221 is 0.8 cm. The diameter d7 of the inner conductor 222 is 0.224 cm. The length i7 of the outer conductor 221 is 4.525 cm. The dielectric constant εr of the dielectric material f7 in the transmission path (coaxial path) 22 is 2.33.

In order to provide a predetermined antenna impedance so as to achieve the maximum receiving sensitivity at a given operation frequency (2.4 GHz in this embodiment), there is a need to adjust the distance between the antenna 21 and the interface between the wall and the space behind of the wall and the distance between the antenna 21 and the apex angle (h7 in FIG. 7) of the reflector 12 to optimum values at the same time.

The optimization processing is performed according to the following procedure. A model in which the dielectric plate is removed from the model shown in FIG. 6 is prepared. In this model, a signal source (internal impedance of 50Ω) is connected to the terminal of the coaxial path, the dipole antenna of the corner reflector is driven as a transmission antenna, and the operation characteristics are analyzed by numeric simulation. Numeric calculation is repeatedly performed while scanning the distance between the dipole antenna and the apex angle of the reflector so as to detect the distance which provides the antenna impedance of 50Ω at a frequency of 2.4 GHz. Next, simulation is executed using the model (in which the distance between the dipole antenna and the apex angle of the reflector is fixed to the optimum value) shown in FIG. 5. In this simulation, a plane wave is emitted from the space on the front side of the wall, and the operation of the antenna system is performed in the receiving mode. The distance (optimum value) which provides the greatest signal electric field strength at the output port (or along the transmission path) is searched for while scanning the distance between the back face of the concrete wall and the tip of the reflector antenna. With the present embodiment, the optimum distance is approximately 10 cm. On the other hand, a state is undesirable in which, if the distance is slightly deflected from the optimum value, the signal electric field strength is greatly reduced. By arranging the λ/4-dielectric plate on the back face of the concrete wall, the change in the signal electric field strength due to the change in the distance can be reduced. The reason is that the impedance in the direction from the back face of the dielectric plate to the front side becomes a value closer to the wave impedance in a free space.

The aforementioned effect is a second effect obtained by introducing the λ/4-dielectric plate. The first effect has been described above (effect in which the standing waves in the interior of the concrete wave are eliminated, thereby reducing transmission loss (comparison between FIG. 2 and FIG. 4)).

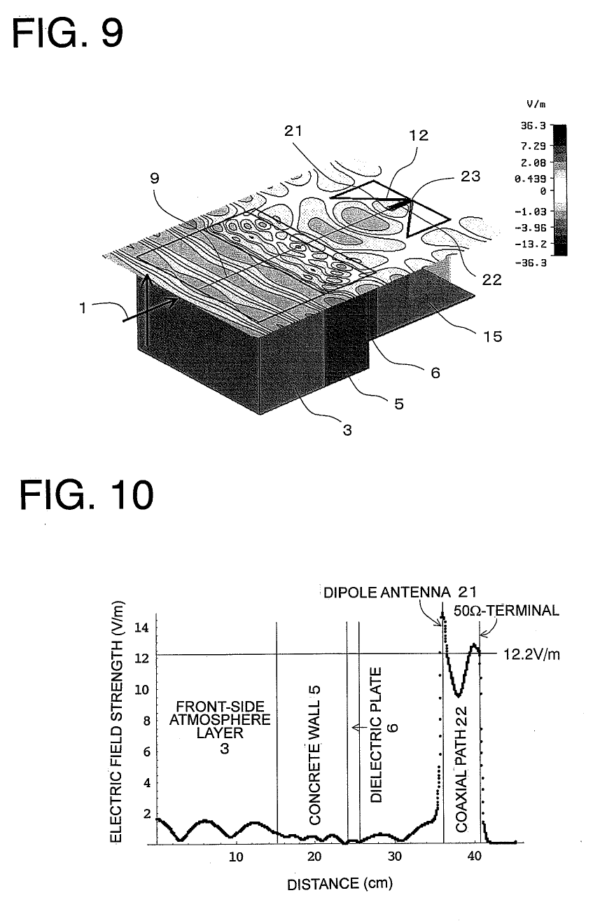

Description will be made regarding the operation of such an arrangement shown in FIG. 5 with reference to FIG. 8 and FIG. 9. FIG. 8 is a central longitudinal cross-sectional view which shows a state (snapshot) of the three-dimensional electromagnetic field at a point in time in the antenna system which has a configuration (first antenna assembly) in which the λ/4-dielectric plate 6, the corner reflector 12, and the dipole antenna 21 are mounted between a pair of conductor plates, i.e., the upper conductor plate 13 and the lower conductor plate 15, in the form of a single unit, and which is arranged behind the concrete wall 5. At the left end face, the vertical polarized plane wave 1 is excited with the strength of 1 V/m. A gray scale contour is shown on the right side of the drawing.

FIG. 9 is a central transverse cross-sectional view (obtained by slicing along the horizontal plane including the electric field strength observation axis 9) which shows a state (snapshot) of the three-dimensional electromagnetic field at a point in time in an arrangement shown in FIG. 5. In FIG. 10, the electric field strength at the terminal of the coaxial path is 12.2 V/m. The estimated value of the voltage applied to the space with a distance of 2.88 mm (=0.4 cm−0.112 cm) between the outer conductor 221 of the coaxial path and the inner conductor 222 thereof is 35 mV(=12.2(V/m)×2.88(mm)).

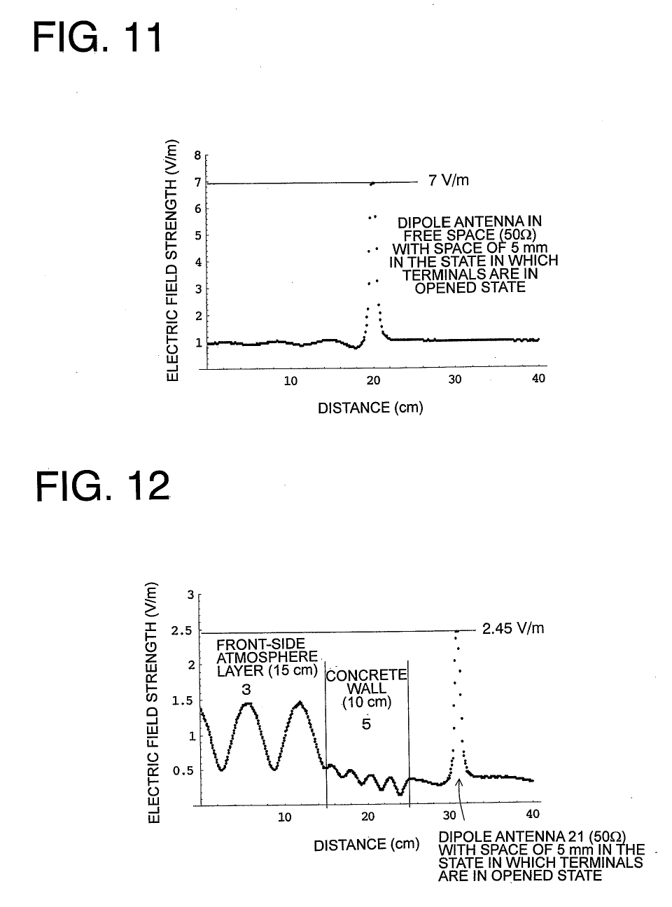

Description will be made regarding a comparison between the above-described system and a comparative model. In the comparative model, as a reference antenna, a dipole antenna with an operation (resonance) frequency of 2.4 GHz, and with the radiation resistance of 50Ω is employed. A plane wave is emitted to the reference antenna located in a free space. FIG. 11 shows the electric field strength distribution along the line (electric field strength observation axis) that passes through the center of the space (5 mm) between the antenna output terminals. This value is obtained under the condition that the terminals are in an open-circuit state. The strength of the traveling wave is ½ of the peak value 7 V/m shown in FIG. 11, and accordingly, the strength of the traveling wave is 3.5 V/m. The voltage applied to the space corresponding to 3.5 V/m is 3.5×5×10⁻³=0.0175 V=17.5 mV.

Next, the same dipole antenna is arranged behind the concrete wall, and a plane wave (with a strength of 1 V/m) is emitted from the front side of the wall. The electric field strength distribution along the measurement axis in such an arrangement is shown in FIG. 12. FIG. 12 shows a one-dimensional electric field strength distribution obtained in such an arrangement in which a plane wave (with a strength of 1 V/m) is emitted from the front side of the wall to a reference dipole antenna disposed behind the concrete wall. Under the condition that the terminals are in an open-circuit state, the electric filed strength peak is 2.45 V/m, and the electric field strength of the traveling wave is 1.23 V/m. The terminal voltage that corresponds to 1.23 V/m is 1.23×5×10⁻³=0.00615 V=6.15 mV. The transmission loss due to the concrete wall is 20 log₁₀(6.15 mV/17.5 mV)=−9.08 dB. This value approximately matches the value calculated from FIG. 1, i.e., 20 log₁₀(0.35/1)=−9.12 dB. As compared with the reference dipole, a receiving apparatus having a gain of approximately 9.1 dB or more serves as an effective means for reducing the transmission loss due to the concrete wall. The corner reflector dipole antenna proposed in the present invention has an estimated gain of 20 log₁₀(35 mV/6.15 mV)=15.10 dB. This gain is much greater than 9.1 dB, and accordingly, a conclusion can be made that the corner reflector dipole antenna proposed in the present invention provides an effective solution.

In the usage 1, a receiver is directly connected to the output terminal 23 of the transmission path (coaxial path) 22, and the signal included in the incident wave 1 is detected and used.

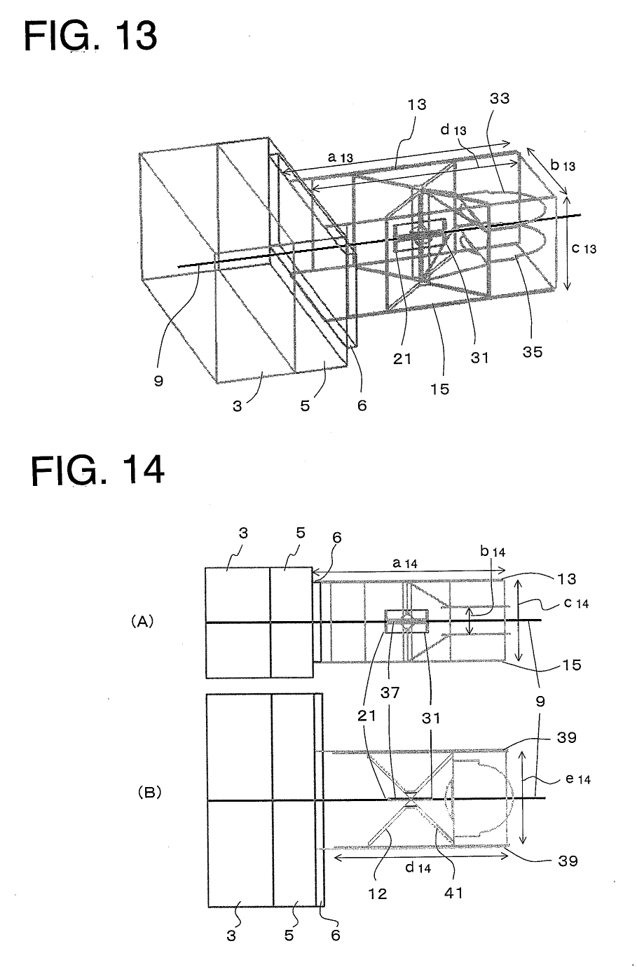

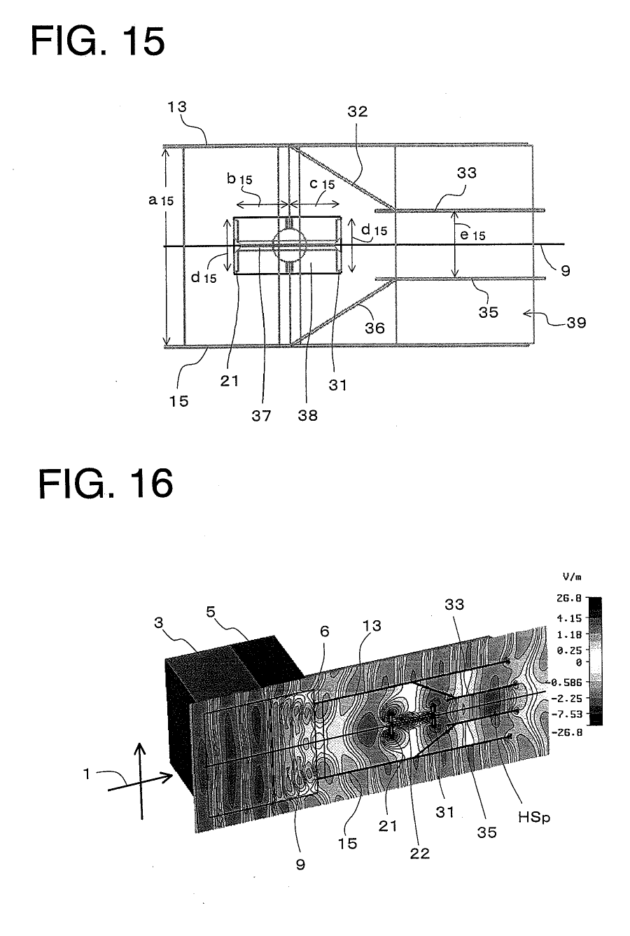

Next, description will be made regarding the usage 2 (behind-the-wall hot spot antenna). In the usage 2, a first antenna assembly and a second antenna assembly are provided in the environment model space 2. With such an arrangement, an additional region (hot spot) in which the electric field strength is greater than the surroundings is formed further behind the second reflector face of the second antenna assembly. Description will be made regarding such an arrangement with reference to an embodiment. FIG. 13 is a schematic perspective view which shows the relation between the embodiment of a behind-the-wall hot spot antenna and a wall or the like. FIG. 14(A) is a longitudinal cross-sectional view of the system shown in FIG. 13. FIG. 14(B) is a horizontal cross-sectional view thereof. FIG. 15 is a vertical cross-sectional view showing the components arranged behind the wall in the embodiment of the behind-the-wall hot spot antenna.

The position relation between the incident wave 1, the front-side atmosphere layer 3, the concrete wall 5, the λ/4-dielectric plate 6, and the electric field strength observation axis 9, and the configuration of the first antenna assembly 11 including the first antenna 21, etc., are approximately the same as those in the above-described embodiment. The second antenna assembly includes a rear-side corner reflector 41 that corresponds to the corner reflector 12 of the first antenna assembly 11 in a back-to-back manner, a second antenna 31, a rear-side upper conductor plate 33, and a rear-side lower conductor plate 35. The transmission dipole antenna (second antenna) 31 is connected to the receiving dipole antenna (first antenna) 21 via a parallel two-line transmission path 37 (70Ω). Furthermore, the rear portions of the aforementioned upper and lower conductor plates 13 and 15 are extended such that they are arranged above and below the second antenna assembly. Also, the side conductor plates 39 and 39 are provided on both sides. Moreover, the rear-side corner reflector 41 is arranged such that it corresponds to the second antenna 31. With such an arrangement, the aforementioned rear-side conductor plate 33 and rear-side lower conductor plate 35 generate reflected waves at their semicircular terminals so as to generate a hot spot at an approximately fixed position on the antenna axis (electric field strength observation axis 9). It should be noted that the rear-side upper conductor plate 33 and the rear-side lower conductor plate 35 are fixed to the upper conductor plate 13 and the lower conductor plate 15 with a rear-side upper inclined conductor plate 32 and a rear-side lower inclined conductor plate 36, respectively. As described above, the size in the height direction is narrowed on the rear side, thereby increasing the electric field strength.

The size of each component will be described below. It should be noted that the structures of the front-side atmosphere layer 3, the concrete wall 5, and the dielectric plate 6 are the same as those in the above-described embodiment, and accordingly, description thereof will be omitted.

The distance a13 (a14) between the back face of the concrete wall 5 and the rear end faces of the side conductor plates 39 and 39 arranged on the both sides is 45 cm. The length d14 of each of the side conductor plates 39 arranged on both sides is 41 cm. The distance b13 (e14) between the side conductor plates 39 and 39 arranged on both sides is 23 cm. The distance d13 between the back face of the dielectric plate 6 and the rear ends of the upper conductor plate 13 and the lower conductor plate 15 is 43.2 cm. The distance b14 (e15) between the rear-side upper conductor plate 33 and the rear-side lower conductor plate 35 is 6.25 cm. The length b15 of the front portion of a dielectric substrate 38 along the axis direction is 5.073 cm. The length c15 of the rear portion of the dielectric substrate 38 along the axis direction is 4.673 cm. The height d15 of the dielectric substrate 38 is 4.85 cm. The distance c13 (c14, a 15) between the upper conductor plate 13 and the lower conductor plate 15 is 18.75 cm.

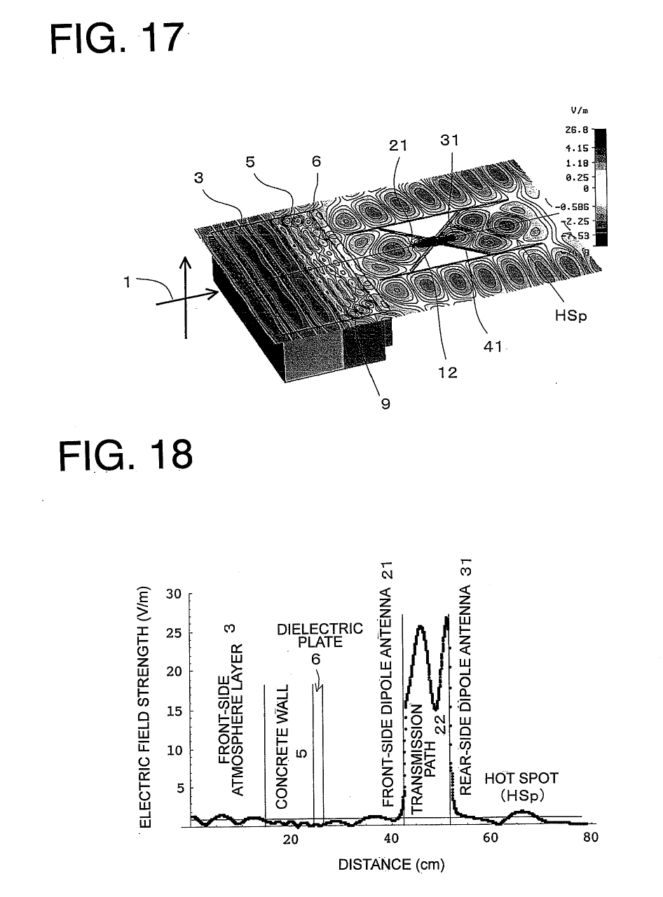

The operation results of the behind-the-wall hot spot antenna having the above-described configuration are shown in FIG. 16 and FIG. 17. FIG. 16 is a central vertical cross-sectional view which shows a model of an electric field strength distribution snapshot. FIG. 17 is a central horizontal cross-sectional view which shows a model of an electric field (vertical direction) strength distribution snapshot. The incident wave is a vertical polarized plane wave having a strength of 1 V/m. It can be understood that a hot spot is formed at the position indicated by “HSp” in FIG. 16 and FIG. 17.

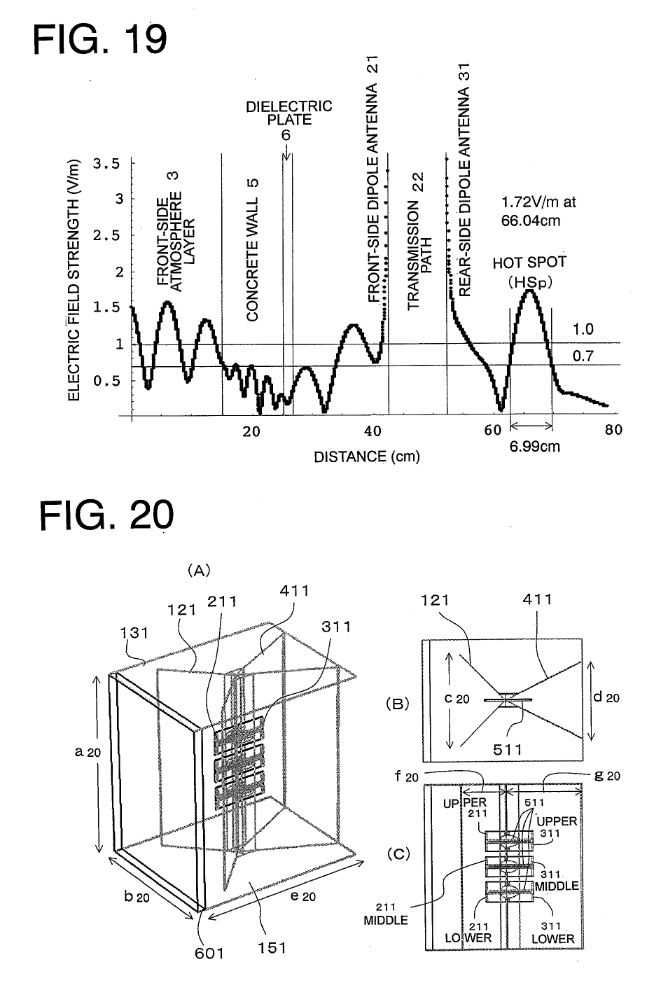

FIG. 18 shows an electric field (vertical direction) strength distribution along the electric field strength observation axis 9. A hot spot is formed in a space approximately 14.5 cm behind the transmission (rear-side) dipole antenna (second antenna) 31. FIG. 19 shows a graph obtained by plotting the graph shown in FIG. 18 with the vertical-axis scale being expanded. As shown in FIG. 19, a hot spot is formed in a space approximately 13.5 cm behind the transmission (rear-side) dipole antenna (second antenna) 31. Here, the hot spot is defined as a region that exhibits the electric field strength of 0.7 V/m(=2×0.35 V/m) or more. In this case, the diameter of the hot spot is 6.99 cm. The electric field strength at the center of the hot spot (at a distance of 66.04 cm) is 1.72 V/m, which is much greater than the electric field strength of 1 V/m of the incident wave.

As the usage of the behind-the-wall hot spot antenna, a usage can be conceived in which an antenna of an indoor LAN repeater or a router receiver is arranged in the hot spot so as to receive a signal. FIG. 18 and FIG. 19 show that the central region in the hot spot has an electric field strength which is greater than the electric field strength of the incident wave. It can be said that, as viewed from the central region in the hot spot toward the front-side space via the concrete wall, the concrete wall is substantially transparent.

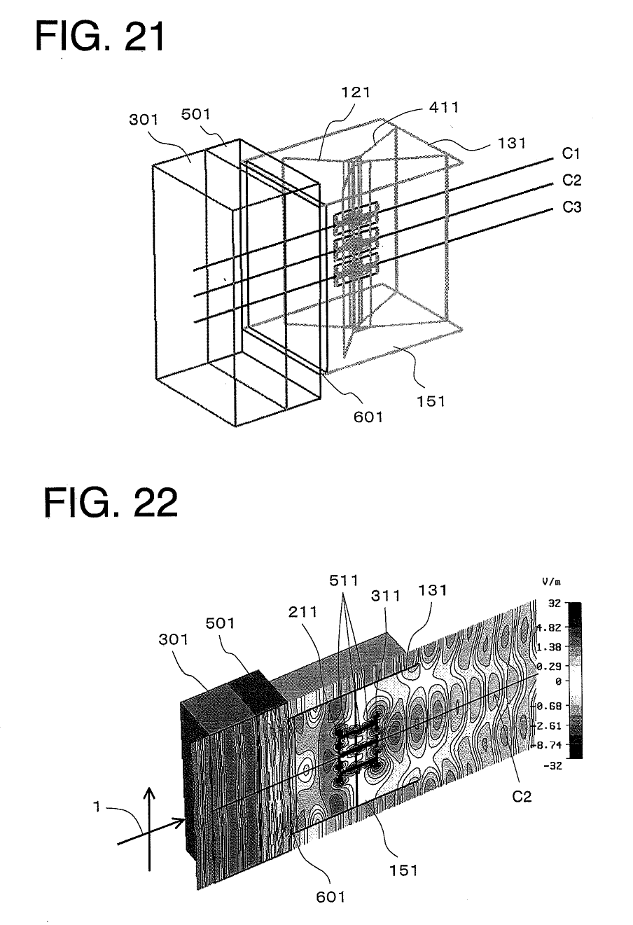

Next, description will be made regarding an embodiment of the usage 3 (formation of a radiation beam in a space behind a wall) with reference to FIG. 20 and FIG. 21. The embodiment allows a radiation beam to be formed with an increased electric field strength in a space behind the wall. That is to say, a radiation beam is formed with a high electric field strength by vertically and horizontally concentrating the radio waves acquired in the space behind the wall. FIG. 20(A) is a perspective view of an embodiment which generates a behind-the-wall beam, FIG. 20(B) is a plan cross-sectional view thereof, and FIG. 20(C) is a longitudinal cross-sectional view thereof. FIG. 21 is a schematic perspective view which shows a state in which a dielectric plate 601 is mounted in contact with a concrete wall 501 in the same way as in the above-described embodiment. The apex angle of a front-side corner reflector 121 is 90°, and the apex angle of a rear-side corner reflector 411 is 55°. The front-side corner reflector 121 and the rear-side corner reflector 411 are arranged in a back-to-back manner. Three pairs of dipole antennas are arranged along the vertical direction in the central portion of these front-side corner reflector 121 and rear-side corner reflector 411.

The λ/4-dielectric plate 601 is disposed in front of the front-side corner reflector 121, and the λ/4-dielectric plate 601 and the antenna structure are arranged in a single unit with upper and lower conductor plates 131 and 151. Each of transmission dipole antennas 311 (upper, middle, lower) is connected to a corresponding receiving dipole antenna 211 (upper, middle, lower) with a transmission path 511 in the form of a pair of the transmission dipole antenna and the receiving dipole antenna. In this embodiment, the sizes of the principal components will be described below. The height a20 of the λ/4-dielectric plate 601 is 43.75 cm, and the width b20 thereof is 32 cm. The length e20 of the upper and lower conductor plates 131 and 151 is 42 cm. The opening width c20 of the front-side corner reflector 121 is 24 cm, and the depth (length in the axial direction) f20 thereof is 12 cm. The opening width d20 of the rear-side corner reflector 411 is 20 cm, and the depth (length in the axial direction) g20 thereof is 20 cm.

Description will be made with reference to FIGS. 22 through 26 regarding a state of the formation of a radiation beam behind the wall provided by an embodiment having the above-described configuration. It should be noted that, as shown in FIG. 21, the axes of the transmission/reception antenna pairs are indicated by C1, C2, and C3.

FIG. 22 is an explanatory diagram which shows an electric field strength distribution on a vertical plane including the electric field strength observation axis C2 in the behind-the-wall antenna system which generates a behind-the-wall beam behind the second antenna assembly by applying the above-described embodiment (first antenna assembly and second antenna assembly) which forms a radiation beam behind the wall to the environment model space 2. The incident wave is a vertical polarized plane wave with a strength of 1 V/m.

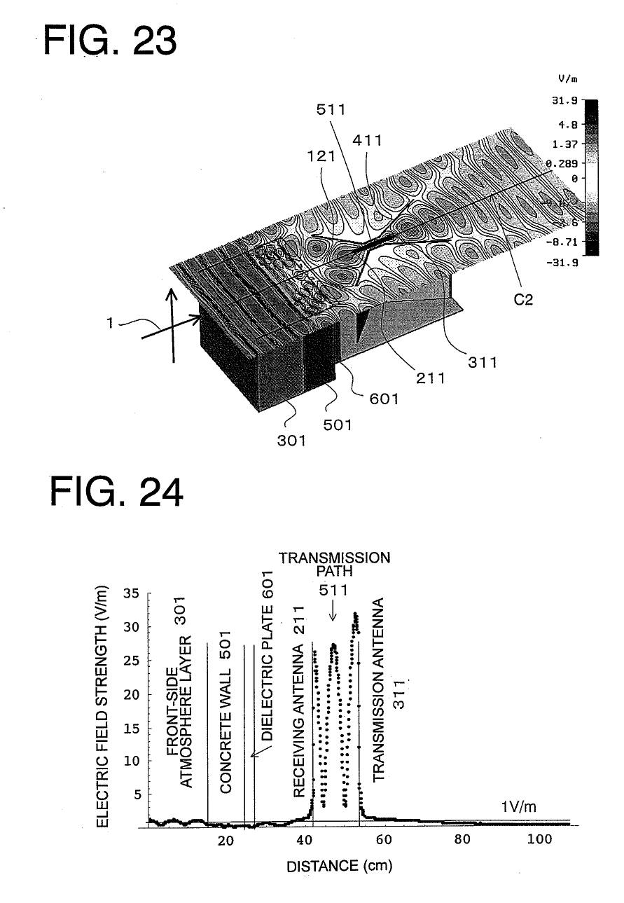

FIG. 23 is an explanatory diagram which shows an electric field strength distribution on a horizontal plane including the electric field observation axis C2 in the behind-the-wall antenna system which generates a behind-the-wall beam behind the second antenna assembly. FIG. 22 and FIG. 23 show a state in which the radio waves acquired by the receiving dipole antenna 211 are transmitted to the transmission dipole antenna 311 via the transmission path 511, and the radio waves thus transmitted are radiated toward the rear-side space. FIG. 22 shows a state in this step in which the radio waves are concentrated in the vertical direction. FIG. 23 shows a state in which the radio waves are concentrated in the horizontal direction. FIG. 22 shows a state in which the radio waves are concentrated near the device located at a central position on the transmission antenna side. The electric field concentration effect can be described as follows. The central antenna device is affected by both the upper and lower antenna devices arranged close to the central antenna device. As a result, the capacitive reactance of the central antenna device is greater than that of the other antenna devices arranged on both sides. Accordingly, when the antenna devices are excited in phase by an incident plane wave, the phase of the signal excited in the central device has a delay as compared with the signal phase in the antenna devices arranged on both side. As a result, although the incident wave is a plane wave, the radiation wave toward the rear-side space is concentrated on a narrow region near the central antenna device.

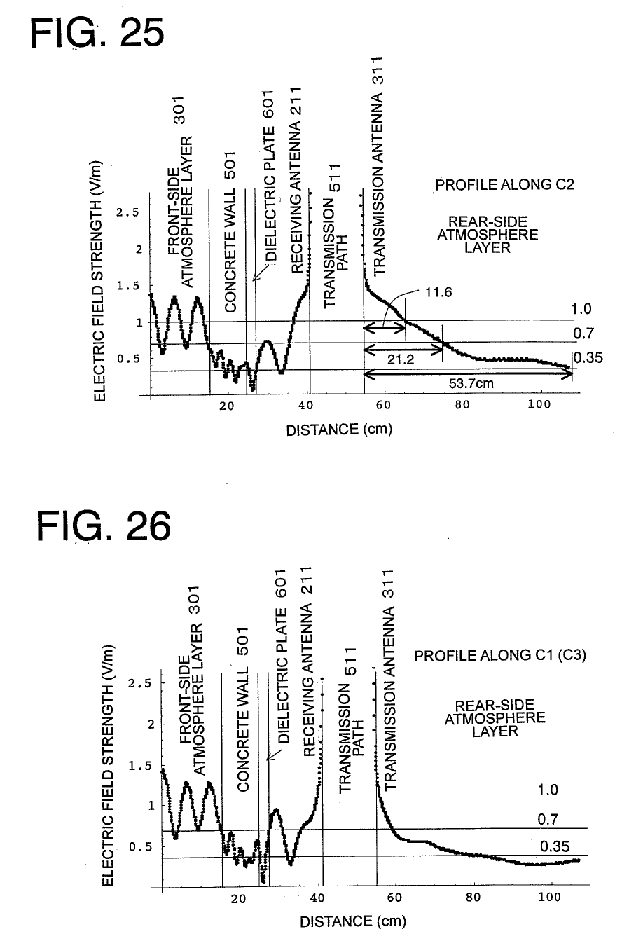

FIG. 24 is a graph which shows an electric filed strength distribution along the electric field strength observation axis C2 (axis of the central antenna pair) in the behind-the-wall antenna system which generates a behind-the-wall beam behind the second antenna assembly. FIG. 25 is a graph obtained by enlarging the scale of the vertical axis shown in FIG. 24, which shows the electric field strength distribution along the electric field strength observation axis C2 (axis of the central antenna pair) in the behind-the-wall antenna system which generates a behind-the-wall beam behind the second antenna assembly. The horizontal axis represents the distance (cm) from the left end of the analysis model. The electric field strength is greater than 1 V/m in a region up to a position 11.6 cm behind the transmission dipole antenna 311. Also, the electric field strength is greater than 0.7 V/m and 0.35 v/m in a region up to a position 21.2 cm and 53.7 cm behind the transmission dipole antenna 311, respectively.

FIG. 26 is a graph which shows an electric filed strength distribution along the electric field strength observation axis C1 (C3) in the behind-the-wall antenna system which generates a behind-the-wall beam behind the second antenna assembly. Making a comparison between FIG. 25 and FIG. 26, it can be understood that the electromagnetic field is concentrated along the axis of the central antenna on the transmission antenna side.

Various modifications may be made with respect to the embodiments described above in detail without departing from the scope of the present invention. Detailed description has been made regarding the embodiments employing a concrete wall. Also, the present invention can be applied to an arrangement employing a wall, floor, etc., semi-transparent to radio waves, in addition to an arrangement employing the concrete wall. The use of the λ/4-dielectric material facilitates the adjustment, in addition to the advantage of increasing the sensitivity, as compared with an arrangement without involving the λ/4-dielectric plate. In order to achieve these effects, various modifications (with respect to the material of the dielectric plate, the number of the dielectric plates) may be made so as to prevent the standing waves from occurring in the interior of the wall, which are also encompassed by the scope of the present invention.

1. A behind-the-wall antenna system comprising:
a wall;
a converging reflector which reflects radio waves so as to form a region behind the wall in which the electric field strength is great;
an antenna arranged in the region between the wall and the converging reflector in which the electric field strength is greater than that in the surroundings; and
a transmission path connected to the antenna,
wherein a resonance space is formed between the front face of the wall and the converging reflector,
the distance between the wall and the reflector is adjusted so as to create an impedance matching state between the antenna and the space on the front side of the wall, and
the radio waves are directly used behind the wall.

2. The behind-the-wall antenna system according to claim 1, wherein a λ/4-dielectric plate is disposed behind the wall.

3. The behind-the-wall antenna system according to claim 1, wherein the converging reflector (first converging reflector) and the antenna (first antenna) form a first antenna assembly,
a second converging reflector, which is arranged in a back-to-back manner with respect to the first converging reflector, and a second antenna for radiating radio waves, which is arranged such that it is corresponds to the second converging reflector and which is connected to the transmission path, form a second antenna assembly, and
an additional electric field distribution is formed in a space behind the wall by means of the second antenna assembly.

4. The behind-the-wall antenna system according to claim 1, wherein an amplifier is connected to the transmission path.

5. The behind-the-wall antenna system according to claim 3, wherein the first and second converging reflectors are corner reflectors, and
each of the first and second antennas is at least one dipole antenna.

6. The behind-the-wall antenna system according to claim 5, wherein each of the first and second antenna assemblies further includes an upper conductor plate and a lower conductor plate.

7. The behind-the-wall antenna system according to claim 3, wherein the second antenna further forms an additional region (hot spot) in which the electric field strength is greater than that in the surroundings, further behind the second converging reflector.

8. The behind-the-wall antenna system according to claim 7, wherein the second antenna assembly includes a rear-side upper conductor plate and a rear-side lower conductor plate, which provides the reflected waves from the output side of the rear-side upper conductor plate and the rear-side lower conductor plate.

9. The behind-the-wall antenna system according to claim 8, wherein each of the rear-side upper conductor plate and the rear-side lower conductor plate of the second antenna assembly has a semicircular shape.

10. The behind-the-wall antenna system according to claim 7, wherein the hot spot is applied to an indoor LAN repeater apparatus.

11. The behind-the-wall antenna system according to claim 3, wherein the radio waves acquired by the first antenna are converged in the vertical direction and the horizontal direction by means of the second antenna assembly so as to output a radiation beam with a high electric field strength.

12. The behind-the-wall antenna system according to claim 11, wherein the first and second antenna assemblies are arranged such that the corner reflectors are arranged in a back-to-back manner, and
the antenna of each antenna assembly is a dipole antenna array.

13. The behind-the-wall antenna system according to claim 12, wherein the apex angle of the corner reflector of the second antenna assembly is smaller than the apex angle of the corner reflector of the first antenna assembly.

14. The behind-the-wall antenna system according to claim 12, wherein the electromagnetic field is concentrated in the antenna array direction using the difference in the magnitude of the reactance component due to the capacitive coupling between the adjacent antenna elements of the dipole antenna array.
